(19) United States
(12) Patent Application Publication
(10) Pub. No.: US 2010/0155993 A1
(43) Pub. Date: Jun. 24, 2010

(54) High Throughput System and Methods of Spark Plasma Sintering

(75) Inventors: Robert Aalund, Elgin, IL (US); Craig Torbitt, Santa Rosa, CA (US)

Correspondence Address: FLIESLER MEYER LLP, 650 CALIFORNIA STREET, 14TH FLOOR, SAN FRANCISCO, CA, 94108, US

(73) Assignee: THERMAL TECHNOLOGY LLC, Santa Rosa, CA (US)

(21) Appl. No.: 12/342,995

(22) Filed: Dec. 23, 2008

(51) Int. Cl. B29C 67/04

(52) U.S. Cl. 264/319; 425/174.4; 425/149

(57) ABSTRACT

A production system and methods for spark plasma sintering. Embodiments of the present invention provide a system and methods that allows for high throughput of material even when using spark plasma sintering technology. The production system includes, among other things, a load lock chamber that accepts a die set that can be loaded with material to be sintered. The die set is passed from the load lock chamber to a sintering chamber wherein the material is sintered. After the material has been sintered, the material is cooled in a cooling chamber. The cooling chamber includes a rotary carrousel that rotates the die set as it is being cooled. Once cooled, the die set including the sintered material can be removed.

### FIELD OF THE INVENTION

The subject matter described herein relates to a high throughput production system and methods of spark plasma sintering.

### BACKGROUND

Spark plasma sintering (“SPS”) is a pressure assisted, high-speed powder consolidation/sintering technology capable of processing conductive and nonconductive materials. Theories on the spark plasma sintering process vary, but most commonly accepted is the micro-spark/plasma concept which is based on the electrical spark discharge phenomenon wherein a high-amperage, low-voltage pulse current momentarily generates spark plasma at high temperatures (many thousands of ° C.) in fine areas between the particles.

During a typical SPS process, repeated application of an ON-OFF DC pulse voltage and current between powder material particles creates spark discharge and Joule heat points between the material particles, thereby providing high-energy pulses at the point of intergranular bonding. The high frequency of the ON-OFF DC pulse energizing transfers and disperses the spark/Joule heat phenomena throughout the specimen, resulting in a rapid and thorough heat distribution, high homogeneity and consistent densities.

Spark plasma sintering's operational or monitored temperatures (200° C.-2400° C.) are commonly 200° C. to 500° C. lower than with conventional sintering, classifying SPS as a lower-temperature sintering technology. Material processing (pressure and temperature rise and hold time) is completed in short periods of approximately five to twenty-five minutes. The relatively low temperatures combined with fast processing times ensure tight control over grain growth and microstructure.

### SUMMARY

According to the embodiments of the present invention, a high throughput production system and methods of spark plasma sintering are provided.

One aspect of the present invention is directed to a production system for spark plasma sintering that includes at least one loading chamber that accepts a die set, the die set including material to be sintered. Once the die set has been placed within the loading chamber, the production system transfers the die set to a sintering chamber. The sintering chamber includes a machine that is operable to perform spark plasma sintering. Once inside the sintering chamber, the material is sintered by the machine using spark plasma sintering technology. After the material has been sintered, the material is transferred to a cooling chamber. The cooling chamber includes a rotary carrousel that holds the die set as it is rotated and cooled within the cooling chamber. Once the die set has been cooled, it is removed from the production system.

Another aspect of the present invention is directed to a production system that is designed to hot-strip the die set within the sintering chamber prior to transferring the die set to the cooling chamber.

Another aspect of the present invention includes methods of operating the high throughput production system.

These and other aspects of the present invention are described in greater detail below.

### BRIEF DESCRIPTION OF THE DRAWINGS

The accompanying drawings, which are incorporated into and constitute a part of this specification, illustrate one or more embodiments and, together with the detailed description, serve to explain the principles and implementations of the invention. In the drawings:

FIG. 1 illustrates a top view of an embodiment of a SPS production system.

FIG. 2 illustrates a side view of an embodiment of a SPS production system.

FIG. 3 illustrates a series of figures depicting a die set as it is being hot-stripped within a SPS machine in accordance with an embodiment of the present invention

### DETAILED DESCRIPTION

Embodiments are described herein in the context of a high throughput production system and methods of spark plasma sintering. Those of ordinary skill in the art will realize that the following detailed description is illustrative only and is not intended to be in any way limiting. Other embodiments of the present invention will readily suggest themselves to such skilled persons having the benefit of this disclosure. Reference will now be made in detail to implementations of embodiments of the present invention as illustrated in the accompanying drawings. The same reference indicators will be used throughout the drawings and the following detailed description to refer to the same or like parts.

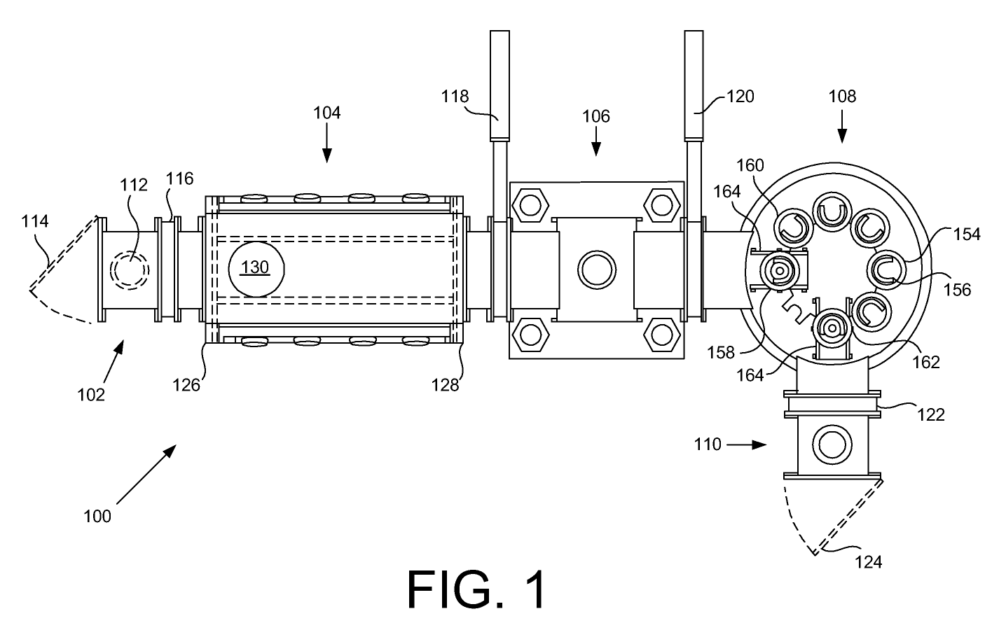

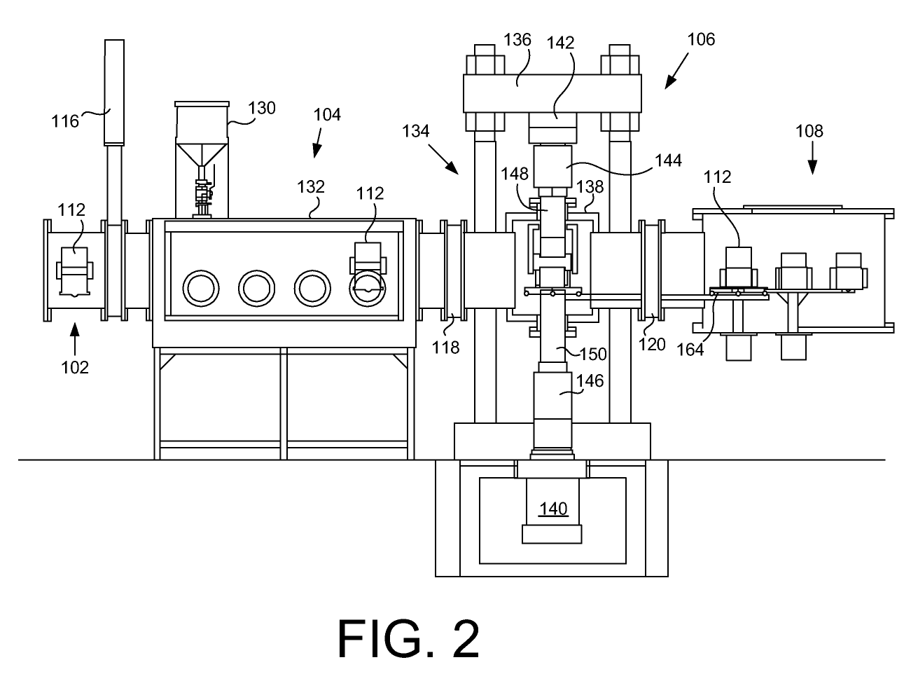

FIGS. 1 and 2 illustrate a top and a side view of SPS production system 100, respectively, in accordance with an embodiment of the present invention. Referring now to FIG. 1, SPS production system 100 can generally be seen as including load lock chamber 102, loading chamber 104, sintering chamber 106, cooling chamber 108 and unloading load lock chamber 110. FIGS. 1 and 2 further illustrate die set 112 as it is passed through the various parts of SPS production system 100.

Referring now to FIG. 1, the automated process of spark plasma sintering implemented by SPS production system 100 begins by placing die set 112 into load lock chamber 102. Load lock chamber 102 can be seen as being flanked by load lock chamber door 114 and isolation valve 116. Load lock chamber door 114 separates load lock chamber 102 from the outside environment while isolation valve 116 separates load lock chamber 102 from loading chamber 104.

In an embodiment, load lock chamber door 114 and isolation valve 116 are automatically operated by SPS production system 100 in tandem in order to isolate the internal environment of SPS production system 100 from its external environment. Accordingly, in an embodiment, at least one of load lock chamber door 114 and isolation valve 116 will be in its closed configuration during operation of SPS production system 100. For example, as die set 112 is loaded into load lock chamber 102, load lock chamber door 114 is positioned in its open configuration while isolation valve 116 is positioned in its closed configuration. Once die set 112 has been placed within load lock chamber 102 at the desired location, both load lock chamber door 114 and isolation valve 116 are positioned in their closed configurations. Next, isolation valve 116 is opened to allow die set 112 to be passed from load lock chamber 102 to loading chamber 104. Once die set 112 has been passed, isolation valve 116 is once again closed and load lock chamber door 114 is subsequently opened whereby the process can be repeated for another die case.

It is noted that all isolation valves and doors utilized by SPS production system 100 can be automatically operated in a similar manner as set forth above, or in any other manner as envisioned by one having ordinary skill in the art, in order to isolate the internal environment of SPS production system 100 from its external environment. In an embodiment, all chambers will be automatically pressure monitored and interlocked so that isolation valves and doors may not be operated if all pressures are not equal. In another embodiment, pump-downs and gas backfills of all chambers will be pressure monitored and interlocked so that preset conditions must be met before sequential steps may occur.

Loading chamber 104 can be seen as being flanked by isolation valve 116 (proximal to the first end 126 of loading chamber 104) and isolation valve 118 (proximal to the second end 128 of loading chamber 104). Isolation valve 116 separates load lock chamber 112 from loading chamber 104. Isolation valve 118 separates loading chamber 104 from sintering chamber 106. In an embodiment, die set 112 may be filled with the material to be sintered prior to placing die set 112 into load lock chamber 102. In another embodiment, the material to be sintered can be inserted into die set 112 within loading chamber 104. In the embodiment of the invention illustrated in FIGS. 1 and 2, fill hopper 130 is positioned on top 132 of loading chamber 104 and supplies the material to be sintered into die set 112. Fill hopper 130 is further illustrated as being positioned proximal to the first end 126 of glove box 104. In this way, the material is allowed to settle within die set 112 as it moves along the length of loading chamber 104. Once die set 112 reaches the second end 128 of loading chamber 104, die set 112 is passed into sintering chamber 106.

Sintering chamber 106 can be seen as being flanked by isolation valve 118 and isolation valve 120. Isolation valve 118 separates loading chamber 104 from sintering chamber 106 and also separates sintering chamber 106 from cooling chamber 108. In an embodiment, isolation valve 118 and isolation valve 120 are both water cooled to compensate for the heat generated by the sintering process. As shown in FIG. 2, the sintering chamber 106 can be seen as including SPS machine 134. SPS machine 134 includes load frame 136, vacuum chamber 138, hydraulic press cylinder 140, load cell 142, upper spacer 144, lower spacer 146, upper cold ram 148 and lower cold ram 150. FIG. 2 illustrates die set 112 loaded into the vacuum chamber 138 of sintering machine 134.

Generally, during SPS machine 134 operation, die set 112 is engaged to vacuum chamber 138 of SPS machine 134 between upper cold ram 148 and lower cold ram 150. Once die set 112 has been properly engaged to vacuum chamber 138, upper cold ram 148 and lower cold ram 150 apply a uniaxial force to the material being sintered. The force is applied while vacuum chamber 138 is operated under negative atmospheric pressure (vacuum) with or without inert gas. As pressure is applied to the material, ON-OFF pulse energizing is simultaneously applied to the material. By generating electrical field energy between particles during compaction, the temperature of the material instantly rises, resulting in the production of high quality sintered compact in only a few minutes. Once SPS machine 134 operation is complete, die set 112 (including the sintered compact) can be disengaged from the vacuum chamber 138 of sintering chamber 106 and passed through isolation valve 120 into cooling chamber 108 to be cooled.

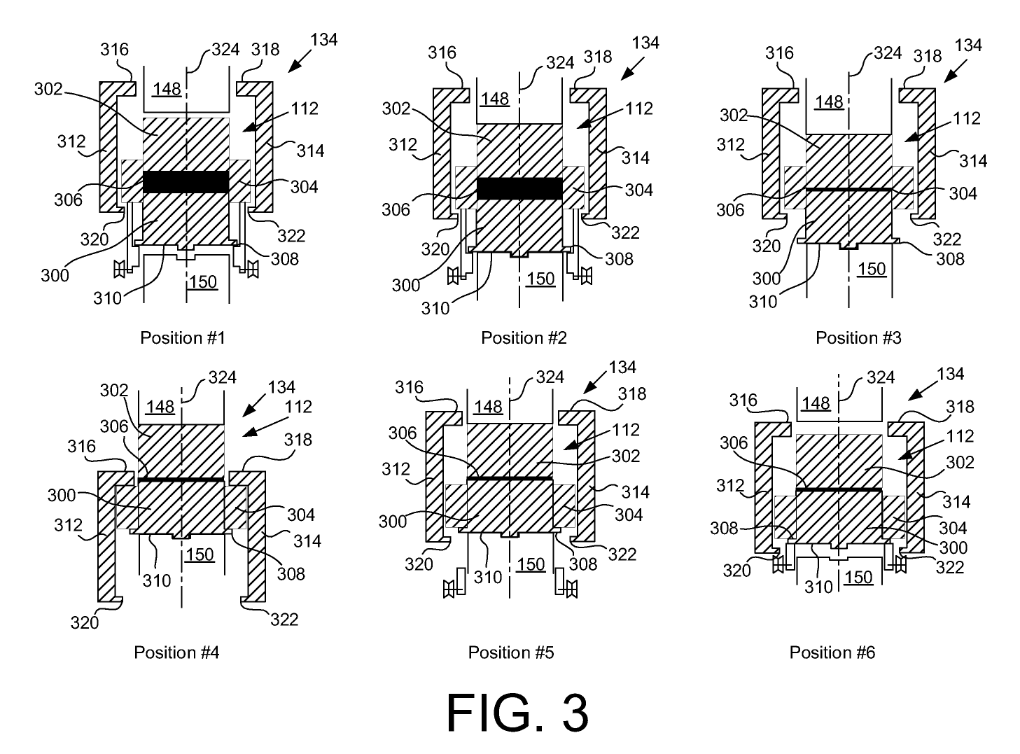

FIG. 3 illustrates a series of figures depicting die set 112 as it is hot-stripped within vacuum chamber 138 (as shown in FIG. 2) of SPS machine 134 in accordance with an embodiment of the present invention. In this embodiment, die set 112 includes lower hot ram 300, upper hot ram 302 and cylindrical casing 304. Material 306 to be sintered is positioned within cylindrical casing 304 between hot rams 300, 302. Lower hot ram 300 also includes bottom ledge 308 that extends away from the bottom 310 of lower hot ram 300 about its periphery. SPS machine 134 is further illustrated as including cold rams 148, 150 and die case supports 312, 314. In this embodiment, die case supports 312, 314 are bracket-shaped and include upper edges 316, 318 and lower edges 320, 322 that extend toward central axis 324.

In position #1, die set 112 can be seen as having been positioned between die case support 312, 314 and between cold rams 148, 150. In this configuration, die case supports 312, 314 have been raised relative to cylindrical casing 304. Consequently, cylindrical casing 304 is located proximal to lower edges 320, 322 of die case supports 312, 314. Cold rams 148, 150 are also disengaged from hot rams 300, 302 in this configuration. In position #2, cold rams 148, 150 have been engaged to hot rams 300, 302. In position #3, the SPS operation is performed. Accordingly, cold rams 148, 150 have been extended for full powder compaction. In position #4, die supports 312, 314 are lowered relative to consolidated material 306. Specifically, as die supports 312, 314 are lowered, upper edges 316, 318 of die supports 312, 314 contact cylindrical casing 304. Once contact is made, die supports 312, 314 continue to be lowered, thereby lowering cylindrical casing 304 relative to consolidated material 306, until the cylindrical casing 304 contacts bottom ledge 308 of lower hot ram 300. In this configuration, the consolidated material 306 is exposed and no longer contained within the cylindrical casing 304. In position #5, die supports 312, 314 are raised relative to consolidated material 306. In position #6, cold rams 148, 150 are retracted and die set 112 including the exposed consolidated material 306 can be removed from vacuum chamber 138 of SPS machine 134.

The process of hot stripping die set 112 within SPS machine 134 is advantageous for several reasons. One advantage is that consolidated material 306 is easier to remove from die set 112 when it is still under heat. One of the reasons for this is that if die set 112 is cooled with consolidated material 306 contained therein, die set 112 and consolidated material 306 will likely cool at different temperatures. In many instances, this can result in consolidated material 306 having a slightly larger diameter than die set 112 as it cools. This can make it difficult to remove consolidated material 306 from die set 112. Another advantage of hot stripping is that it helps protect die set 112 from becoming damaged as consolidated material 306 is removed. In the preferred embodiment, die set 112 is made of graphite. One of the physical properties of graphite is that it actually increases in strength under increased heat. Accordingly, by hot stripping die set 112 within SPS machine 134, consolidated material 306 is removed from die set 112 when the graphite is at its strongest. Other advantages of hot stripping die set 112 within SPS machine 134 also exist as will be readily apparent to one having ordinary skill in the art having the benefit of this disclosure. It is also to be understood that other hot stripping methods and mechanisms to implement those methods can be used as would be apparent to one having ordinary skill in the art having the benefit of this disclosure and still fall within the scope of the invention disclosed herein.

Referring again to FIG. 1, cooling chamber 108 can be seen as being flanked by isolation valve 120 and isolation valve 122. Isolation valve 120 separates sintering chamber 106 from cooling chamber 108 while isolation valve 122 separates cooling chamber 108 from unloading load lock chamber 110. In this embodiment, cooling chamber 108 can be seen as including a rotary carrousel 152 having a plurality of cradles 154 for holding die set units. In an embodiment, each cradle 154 includes a griping device (e.g., handles or arms) 156 to grasp die set units within cooling chamber 108. In an embodiment, cooling chamber 108 operates under vacuum and/or under inert gas conditions.

A rotary carrousel is used within cooling chamber 108, among other reasons, to minimize the space required for cooling chamber 108 while maximizing the amount of time that the sintered material remains in cooling chamber 108 under vacuum and inert gas conditions. Limiting the volume of cooling chamber 108 limits the space that has to be maintained under normal operating conditions for cooling chamber 108, thereby decreasing overall operating expenses.

In this embodiment, rotary carrousel 152 can be seen as including a substantially circular configuration having eight cradles 154 along its periphery. In use, die set 112 is initially placed in a cradle 154 at loading position 158. Die set 112 is held at loading position 158 while the SPS process is performed on another specimen. Once another specimen has been sintered, rotary carrousel 152 can be rotated within cooling chamber 108 to place die set 112 at position 160, while the next sample is loaded into cooling chamber 108 at position 158. Rotary carrousel 152 is continually rotated within cooling chamber 108 in this manner. Once die set 112 reaches and has been cooled at unloading position 162, die set 112 is removed from cooling chamber 108 and placed into unloading load lock chamber 110. While FIG. 1 illustrates rotary carrousel 152 as including eight cradles 154, it is to be understood that rotary carrousel 152 can include any number of cradles 154 and still fall within the scope of this invention. It is also to be understood that rotary carrousel 152 may have any other comparable configuration and still fall within the scope of this invention. For example, rotary carrousel 152 may also have a coiled or helical configuration within cooling chamber 108 and still fall within the scope of this invention.

Finally, unloading load lock chamber 110 can be seen as being flanked by isolation valve 120 and unloading chamber door 124. Isolation valve 122 separates cooling chamber 108 from unloading load lock chamber 110 while unloading load lock chamber door 124 separates unloading load lock chamber 110 from the outside environment. Unloading load lock chamber 110 accepts die set 112 after it has been cooled within cooling chamber 108. Die set 112 can thereafter be removed from SPS production system 100 by any means as would be apparent to one having ordinary skill in the art having the benefit of this disclosure.

The embodiment of SPS production system 100 illustrated in FIGS. 1 and 2 and described above can be designed to produce 60 parts per 24-hour day based on a 24-minute complete cycle. This assumes are 12-minute SPS process time. It is also assumed that a die set will be loaded with powder and moved in position in 24 minutes. This timing does not include down time. Nevertheless, it is to be understood that SPS production system 100 is not in any way limited to producing 60 parts per 24-hour day.

Die set 112 can be transferred within SPS production system 100 using any method that would be apparent to one having ordinary skill in the art having the benefit of this disclosure. In an embodiment, die set 112 is transferred within SPS production system 100 by placing die set 112 on carriage 164 (as shown in FIGS. 1 and 2). In another embodiment, a conveyor belt, or hydraulic or pneumatic tray transfer system may be used to transfer die set 112 within SPS production system 100.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modification that are suited to the particular use contemplated. It is intended that the scope of the invention be defined by the claims and their equivalents.

1. A production system for spark plasma sintering, comprising:
a first chamber that accepts a die set, the die set comprising material to be sintered;
a sintering chamber comprising a machine that is operable to perform spark plasma sintering, wherein the die set is transferred by the production system from the first chamber to the machine, wherein the machine sinters the material within the die set using spark plasma sintering technology; and
a cooling chamber that receives the die set from the sintering chamber after the material has been sintered, wherein the cooling chamber comprises a rotary carrousel that holds the die set as it is rotated and cooled within the cooling chamber.

2. The system of claim 1, wherein the cooling chamber operates under vacuum and under inert gas conditions.

3. The system of claim 1, wherein the rotary carrousel comprises a plurality of cradles to hold the die set.

4. The system of claim 2, wherein each of the plurality of cradles includes a gripping device to grasp the die set.

5. The system of claim 1, wherein said rotary carrousel comprises a substantially circular configuration.

6. The system of claim 1, wherein said rotary carrousel comprises a coiled configuration.

7. The system of claim 1, wherein the die set is hot-stripped within the sintering chamber.

8. The system of claim 1 further comprising doors and isolation valves, wherein said doors and isolation valves are operated to isolate the internal environment of the production system from the production system's external environment.

9. The system of claim 7, wherein all chambers are automatically pressure monitored and interlocked, wherein the isolation valves and doors are not be operated if all pressures are not equal.

10. The system of claim 7, wherein pump-downs and gas backfills of all chambers are pressure monitored and interlocked, wherein preset conditions must be met before sequential steps occur.

11. The system of claim 1, wherein said sintering chamber is flanked by water cooled isolation valves.

12. The system of claim 1 further comprising a fill hopper that fills the die set with the material to be sintered within the first chamber.

13. A method of spark plasma sintering, comprising the steps of:
loading a first chamber with a die set, said die set comprising material to be sintered;
transferring said die set to a sintering chamber comprising a machine that is operable to perform spark plasma sintering;
sintering the material within the die set using spark plasma sintering technology;
transferring the die set to a cooling chamber after the material has been sintered;
cooling the material within the cooling chamber, wherein the cooling chamber comprises a rotary carrousel that holds the die set as it is rotated and cooled within the cooling chamber; and
transferring the die set to an unloading load lock chamber.

14. The method of claim 13, wherein the cooling chamber operates under vacuum and under inert gas conditions.

15. The method of claim 13, further comprising the step of hot-stripping the die set within the sintering chamber after sintering the material.

16. A production system for spark plasma sintering, comprising:
a load lock chamber that accepts a die set;
a loading chamber that receives the die set from the load lock chamber, wherein the die set is loaded with a material to be sintered within the loading chamber;
a sintering chamber comprising a machine that is operable to perform spark plasma sintering, wherein the sintering chamber accepts the die set from the loading chamber, wherein the machine sinters the material within the die set using spark plasma sintering technology, wherein the die set is hot-stripped within the sintering chamber;
a cooling chamber that receives the die set from the sintering chamber after the material has been sintered, wherein the cooling chamber comprises a rotary carrousel that holds the die set as it is rotated and cooled within the cooling chamber; and
an unloading load lock chamber that receives the die set from the cooling chamber.
